(19) United States
(12) Patent Application Publication
(10) Pub. No.: US 2002/0068593 A1
(43) Pub. Date: Jun. 6, 2002

(54) Method for increasing the bit rate in a telecommunications network with data and speech transmission

(75) Inventors: Bruno Deltour, Paris (FR); Gilles Michalon, Colombes (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THALES, PARIS (FR)

(21) Appl. No.: 09/987,545

(22) Filed: Nov. 15, 2001

(30) Foreign Application Priority Data
Nov. 17, 2000 (FR) 00 14887

(51) Int. Cl. H04B 7/005

(52) U.S. Cl. 455/502; 370/350

(57) ABSTRACT

To increase the telecommunications bit rate in a network of stations sending both data and speech, the data and speech sub-channels are time-multiplexed with a general services and synchronization sub channel. This enables the most efficient use of the former two sub-channels which can used, if need be, so that both of them transmit either speech or data if the ratios between the respective quantities of information to be sent in these categories of information favors one of these categories.

### BACKGROUND OF THE INVENTION

1. Field of the Invention

The present invention relates to a method for increasing the bit rate in a telecommunications network with data and speech transmission.

In VHF narrowband (for example 25 kHz band) radio transmissions, the radio channel is time-shared between sessions of speech transmission (i.e. voice communications between different operators) and sessions of data transmission (operational messages, positional messages, data files etc.).

2. Description of the Prior Art

At present, VHF equipment cannot be used for the simultaneous transmission of speech and data: the transmissions are made one after the other.

One possible means of protecting the equipment against electronic countermeasures is the frequency-hopping mode of operation.

Frequency hopping consists of the use of a frequency only during a specified time (a plateau). At present, this time is in the range of some milliseconds for VHF equipment. The transmission of the information is done in n plateaus. The order in which the frequencies are used is drawn randomly.

A particular station, known as the master of the network, may synchronize the entire network.

The transmission is done generally in conference. This means that any operation of sending by one of the units of the network is received by all the other units. These other units then cannot go into sending mode so long as the previous transmission is not finished (this is known as half-duplex operation or alternating operation).

Owing to half-duplex operation mode, any radio unit that wishes to go into sending mode (for sending speech or data) must first of all wait for the VHF channel to be released before it goes into sending mode. Rules of priority may be defined, if necessary, in order to obtain passage for a sending operation that has greater priority than the transmission in progress.

When the network carries out both speech transmission and data transmission, these transmissions have to be made one after the other. However, this creates many difficulties.

In general, the transmission of data is done by computers connected to the radio units. These computers do not know whether or not the channel is being used for speech transmission when they make a request for data transmission.

If a speech transmission is in progress, the data transmission cannot be made unless the operator releases the half-duplex operation. His partner must then wait for the end of the data transmission before taking his turn to speak. Another possibility is to keep the data transmission pending. This can be done only after a time lag following the last speech alternation in the half-duplex operation.

If the speech transmission has priority over the data transmission, then when the speech transmission takes its turn in the half-duplex alternation, this will interrupt a data transmission in progress. The end of the message (or the totality of this message) will be retransmitted after the end of the alternate turn taken up by speech. The consequence of this will be to increase the total time needed to convey data.

In the above operation, it can be seen that when the system used is one that frequently sends data, the speech communications will be disturbed. On the other hand, the data transmission will also be disturbed by the speech transmission.

The result of this is that the data transmission must be limited to about 20 percent of the channel occupancy if it is desired to have the ability to take over the channel for alternating speech transmission namely speech transmission in half-duplex mode, within a reasonable time limit. Now in recent years, data transmission is taking an increasingly greater share of transmission.

Another possibility is to have two VHF radio units working on two different channels, one for the speech transmission and the other for data transmission.

### SUMMARY OF THE INVENTION

An object of the present invention is a method to increase the information (data and/or speech) bit rate in a relatively narrow-band network (for example a network with a band of some tens of kHz), while at the same time efficiently averting the risks of collision between simultaneous or proximate requests for transmission.

The method according to the invention consists of the time-multiplexing of the data and speech sub-channels with a general services and synchronization sub-channel to form a frame consisting of an alternation of data, speech and synchronization slots.

### BRIEF DESCRIPTION OF THE DRAWINGS

The present invention will be understood more clearly from the following detailed description of a mode of implementation, taken as a non-restrictive example illustrated by the appended drawings, wherein:

FIG. 1 is a simplified drawing of an exemplary frame of the time-multiplexed signal according to the method of the invention;

FIG. 2 is a simplified drawing illustrating the working of the alternating mode in speech transmission, by means of the representation of a frame such as the one shown in FIG. 1;

FIG. 3 is a drawing illustrating the way in which the method of the invention averts a collision of proximate transmission requests made by two units of the network;

FIG. 4 is a drawing similar to that of FIG. 2 for the transmission of data; and

FIGS. 5 and 6 are drawings providing an illustration, according to the invention, of the recovery of the speech sub-channel used for the data transmission after the end of the data transmission and during data transmission respectively.

### MORE DETAILED DESCRIPTION

The present invention is described here below with reference to a VHF radio telecommunications network for the simultaneous transmission of data (any data pertaining to measurements, images etc) and of speech. However, it is clearly understood that the invention is not limited to this application and that can it can equally well be implemented when only data or only speech has to be transmitted, whether in VHF or in other frequency ranges.

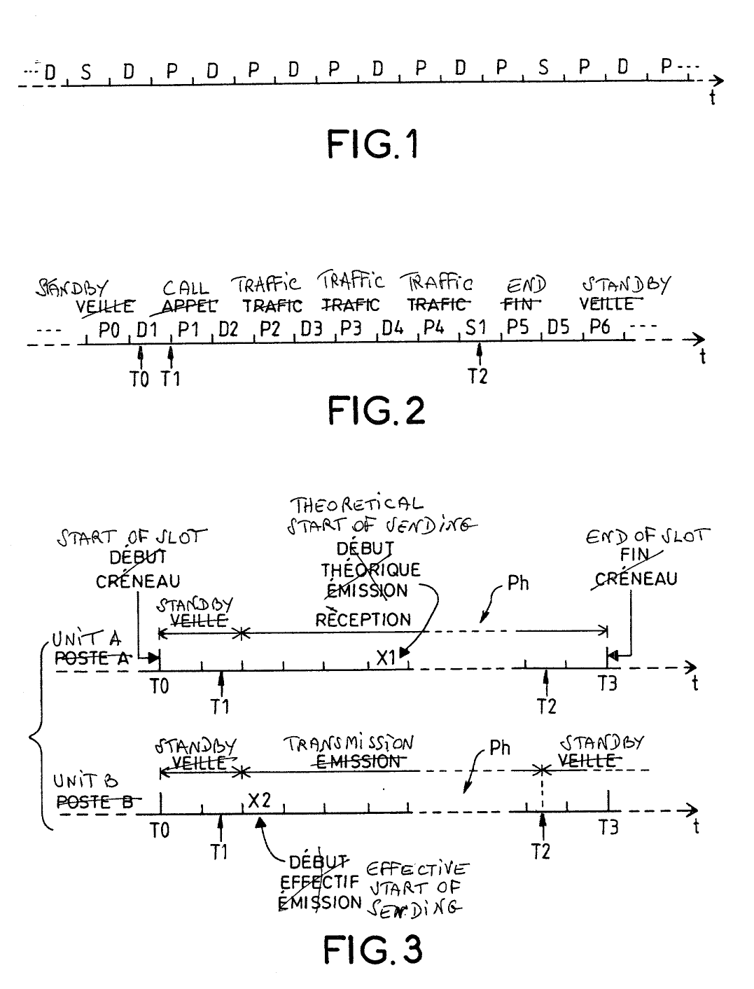

Referring to FIG. 1, an explanation shall be given of an essential characteristic of the method of the invention. According to this method, a VHF transmission channel is subdivided into three distinct sub-channels: one speech transmission sub-channel P, one data transmission sub-channel D, and one sub-channel to provide especially for the synchronization S of the network using this VHF Channel. This network comprises, for example, several tens of transmitter-receiver units. One of these units may be the master unit of the network, and in this case it is the supervisor of the synchronization sub-channel. However, the network implementing the method of the invention does not necessarily have a master unit. Should there be no such master unit, every unit of the network is equally entitled to play a role in this synchronization sub-channel.

According to the method of the invention, the three above-mentioned sub-channels P, D, S are time-multiplexed. The time frame thus constituted comprises, within one period, several alternations of sub-channel P and D slots and generally only one sub-channel S slot. In the example shown, all the slots have the same duration, but this is not necessarily the case. In the example of FIG. 1, each period has five P slots alternating with five D slots and only one S slot, but it is clearly understood that these figures may be different, especially depending on the ratio of the expected or foreseeable loads in speech and in data transmission. The duration of each of these P, D and S slots depends especially on the bandwidth of the VHF channel and on the foreseeable load in speech and data transmission. For example, for a bandwidth of 25 kHz and a network with a few tens of transmitter-receiver units, the duration of a slot may be some tens of milliseconds.

The synchronization sub-channel is not only used for the common synchronization of all the units of the network, but can also be used for different tasks pertaining to links between at least two units of the network. For example, these tasks may be one of the following: a request for priority transmission formulated by a unit, a warning reported by a unit, a “flash” message, a request for the repetition of a message, commands sent out by the master unit, reconfiguration of the network etc. According to an exemplary implementation, frequency agility is used in the event of risks of interception and/or jamming. In each speech synchronization and data slot, the master unit controls one or, preferably, several random frequency jumps produced in a manner known per se. For slots with a duration of some tens of milliseconds, the number of frequency hops in each slot may be for example 20 to 30.

According to one characteristic of the invention, each data, speech and synchronization slot comprises a first part (which, for example, may last for a period equal to several tens of percentage points as a proportion of the total duration of the slot) devoted to synchronization on a synchronization signal sent by one of the units of the network, which is in transmission, or else by the master unit. The remainder of the slot is devoted to the transmission of a useful signal if it exists (signal P, D or S). The synchronization sent on the sub-channel P or D enables the units to get re-synchronized with fine precision on the transmitter of the speech P or data D in question. The synchronization sent on the sub-channel S guarantees the consistency of the network by re-synchronizing each station with the master of the network.

FIG. 2 exemplifies a section of a VHF signal during the sending of a short message on the speech channel. At the instant T0, which is situated after a free slot P0 (with the speech transmission on standby) and at the start of a slot D, referenced D1, the operator of a unit activates the alternating switch of this unit. Given that, at the instant T0, a data slot is begun, the unit in question waits for the next speech slot P1 that occurs at the instant T1. It is assumed that, at this point in time, no other unit is sending speech. The unit in question may therefore send out a call in the useful part of the slot P1 so that it can send speech immediately afterwards, in the slots P2 to P4 (which alternate with the slots D2 to D4). A synchronization slot S1 follows the slot P4. It is assumed that the operator, having finished transmitting what he had to say, releases his unit's alternating switch at an instant T2, during the slot S1. During the slot P5, which immediately follows S1, the end of the alternation signal is sent and all the units of the network return to the speech standby state, pending the signalling of the next activation of the alternation. It will be noted that each station of the network working in receiver mode (namely all the units except the one in which the alternation has been activated) get reset to the synchronization signals sent out at the beginning of P1. This synchronization is stored in each of these receiver units and resumed at each start of a communications slot of the speech sub-channel. This is done so long as the operator has not released the alternation. As soon as the slot corresponding to the end-of-speech alternation is received (P5 in FIG. 2), all the units of the network return to alternation standby on the speech sub-channel and retake, on this channel, the synchronization sent by the master unit of the network.

In order to avert the largest possible number of collisions in the taking of alternating roles (i.e. to prevent the effects of blocking that would be caused by the simultaneous or quasi-simultaneous arrival of requests for speech transmission, especially when this sub-channel is occupied by one of the units), the method of the invention provides for an anti-collision procedure. This procedure consists for example in making each unit that wishes to go into speech transmission draw a random number X corresponding to a time span that elapses from the instant of the drawing of this number. Sending operation from each of the units in question will be possible, at the earliest, only after the corresponding period of time has elapsed. FIG. 3 shows a simplified example of the implementation of this process. Let us take two units A and B simultaneously requesting permission to send. Their requests occur at an instant T1, shortly after the start T0 of a speech slot Ph. This slot Ph is shown twice in FIG. 3 for the clarity of the explanations. It is assumed that, between the instants T0 and T1, no unit of the network is sending speech and that, therefore, this part of the slot is on standby for speech transmission. In FIG. 3, the slot Ph has been subdivided into several plateaus (each corresponding to a different frequency of transmission). It is assumed that the unit A is assigned the number X1 corresponding to five plateaus and that the unit B is assigned the number X2 corresponding to a single plateau. Consequently, the unit B can send as soon as the first following plateau T1 occurs. The sending from the unit B lasts up to an instant T2 situated, for the example shown, close to the end of the slot Ph. Since X1>X2, the unit A is not entitled to send so long as the unit B is sending, i.e. not before the instant T2. Naturally, if the sending from the unit B lasts beyond the end of the slot Ph, it will continue on the next plateau or plateaus of the speech slots Ph+1, Ph+2 etc. It is also clear that if, at the instant T1 or at an instant situated between T1 and the 5^{th} plateau, a third unit C requests permission for sending, and if the number X3 assigned to it is such that the theoretical start of its sending is situated before that of the unit A (before the 5^{th} plateau of the slot Ph), it could send before the unit A, as soon as the sending from the unit B is ended. It may also happen that the theoretical start of sending from the unit C coincides with that of the unit A. In such a case, according to another aspect of the method of the invention, depending especially on the number of units of the network, either another draw of random numbers is made for the units A and C or provision is made, during the designing of the network or even in operational mode, for a hierarchically organized priority of the different units.

If the number X1 were to be substantially greater than X2, and if there were to be many requests for sending from other units occurring between T1 and the theoretical start of sending from the unit A, and if the random numbers assigned to the other units were such that their respective theoretical starting points of sending were situated before that of the unit A, the transmission from this unit could be greatly delayed. To prevent such a situation, the method of the invention gives the unit A priority over all the other units that have sent a request for permission after itself, if it has not been able to obtain permission to transmit at the end of a specified period of time after the theoretical start determined by X1. The invention therefore postpones the respective instances of permission for the other units to after the end of transmission from the unit A (which itself awaits the end of transmission from the units that had priority over it).

According to one variant of the method of the invention, a rotating priority given to the units wishing to make transmission. In other words, all the pending applications are examined in a pre-established order and permission is granted to them in this order as soon as the currently sending unit has ended its session. However, this order may be shifted if a unit having absolute priority wishes to make transmission, and transmission by the currently sending unit may even be interrupted. This request by the unit with absolute priority is sent on the synchronization channel and is immediately taken into account at the very first speech slot following the synchronization slot.

Naturally, other methods of preventing collision between transmission requests may be implemented.

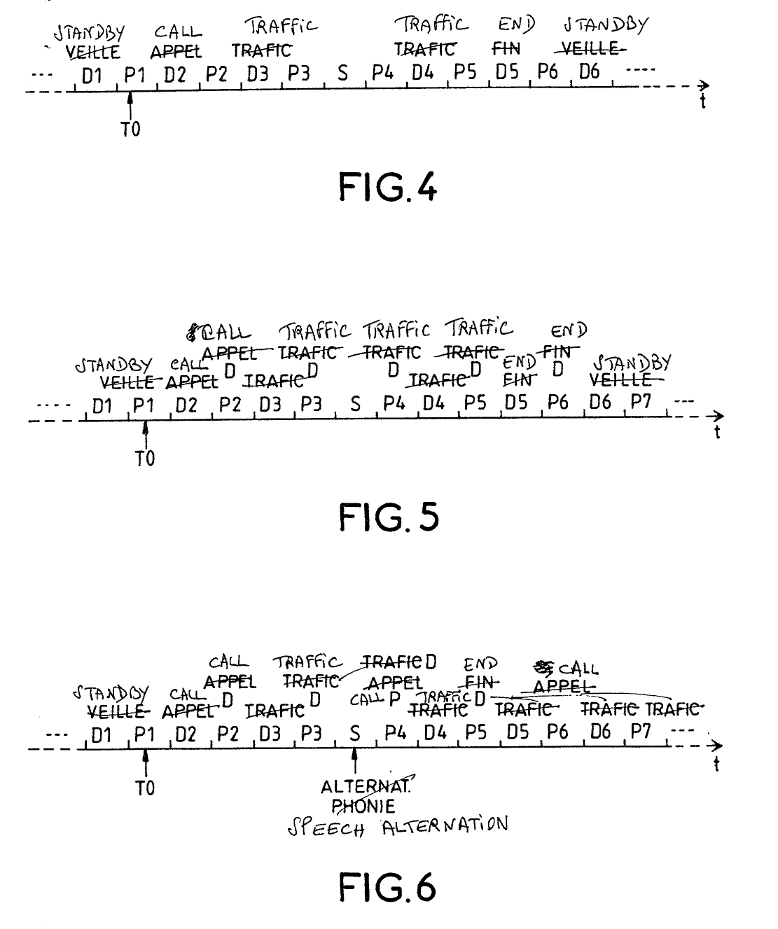

FIG. 4 shows an exemplary section of a network frame according to the invention, pertaining more particularly to a data transmission method. It is assumed that there is no traffic on the data sub-channel at the start of this frame section. The first data slot D1 is then in the standby state and all the receivers of the units of the network are listening to the data sub-channel. It is assumed that, at an instant T0, situated at the beginning of the speech slot P1, coming immediately after D1, one of the units of the network (the unit A for example) sends a sending request. This request is taken into account at the data slot D2 coming immediately after P1. The call is therefore effectively passed to the start of D2 and since no other unit sends requests for permission to send data, the unit A may immediately send its data, starting in the slot D2. It is assumed that the unit A must send data during a time span greater than the duration of the two slots. It therefore sends its data during D3, D4 and during a part of D5. At the end of this sending operation, the unit A sends its end-of-sending signal during D5. As soon as the next data slot D6 occurs, the data sub-channel goes into the standby state. Naturally, the same methods of collision prevention as those described here above with reference to the speech sub-channel are applicable to the data sub-channel.

The data sub-channel is used for sending messages or files at different bit rates. In the same way as for the speech sub-channel, the lower the useful bit rate, the greater the resistance to jamming. It is also possible to implement a data encoding. This encoding may be of any known type. The data transmitted on the data sub-channel are independent of the speech. When a unit wishing to send data sends out a sending-request signal, the concerned receiver unit or units get reset in data-sending mode upon reception of the slot pertaining to the call (slot D2 in FIG. 4). This synchronization is stored and resumed at each start of a data slot (D3, D4 etc in FIG. 4), so long as the sending of data continues. Upon reception of the signal pertaining to the end of sending of data (slot D5 in FIG. 5), all the units of the network go back to the standby state on the data sub-channel and, on this data sub-channel, they resume the synchronization received from the master unit of the network.

The synchronization sub-channel is used by the master unit of the network to maintain the synchronization of all the units of the network, and to this end, at the beginning of each synchronization slot, it sends a synchronization pattern (for example a succession of signals at different frequencies each comprising a synchronization code).

This synchronization of the units of the network enables then to get into a state where they can receive the data at very high speed (typically within less than 500 ms) both on the data sub-channel and on the speech sub-channel.

Furthermore, this synchronization sub-channel is used, according to the invention, for the transmission of different pieces of information, whether general or specialized, on the second part of each synchronization slot, after the first part which is reserved for the synchronization signals proper. To this end, this sub-channel may be used both by the master unit and by all the other units of the network.

These pieces of information especially comprise the sending of a warning message (a general warning or else a warning to the master unit and/or certain units more particularly concerned by this warning), a “flash” message (information of particular utility for all the units or for a section among them), particular requests (pre-empting of the speech or data sub-channel). This information is sent without disturbing the operation of the data sub-channel or that of the speech sub-channel. The master unit, or even one of the units of the network, can also transmit special messages on the synchronization sub-channel, for example messages of general utility (end of operation, changing frequency of transmission, change of encoding etc) or messages pertaining to the reconfiguration of the network (changes in the frames of the number of speech slots with respect to the number of data slots, duration of the slots etc) or messages authorizing the sending of speech on at least one part of the speech slots. To accelerate the procedure for sending information on the synchronization sub-channel, it is possible to assign each category of information and/or each piece of information an identification number that can be transmitted very speedily.

FIG. 5 shows a frame section showing an exemplary process wherein the speech channel is recovered for data. It is assumed that, just before this process is undertaken, the data and speech sub-channels are on standby: the slots D1 and P1 indicate this standby state. At an instant T0 situated at the beginning of P1, a unit A of the network reports that it has to transmit a large number of pieces of data urgently and that it therefore wishes to use both the data sub-channel and the speech sub-channel. This request is immediately granted since these two sub-channels are on standby (if other units had been the process of transmitting data and/or speech, and if the transmission from the unit A had been deemed to have priority by the master unit, this master unit would have ordered all the other active units to suspend their respective transmission operations to be able to give priority to the unit A). The unit A therefore begins its process immediately at the slot D2 on which it launches its call for making total use of the data sub-channel. Then it launches a call on the slot P2 to be able to use the speech sub-channel and starts sending its data on D3, then P3, D4, P4 etc. It is assumed that the last data of the unit A is transmitted on D5. The unit A then sends an end-of-sending signal on D5, then on D6 (which immediately follows D5), in order to release the two corresponding sub-channels. This results in these two sub-channels being placed on standby as soon as the slots D6 and P7 occur.

FIG. 6 relates to a variant of the case illustrated in a simplified way in FIG. 5. This is the case where, during the transmission of data by the unit A on both sub-channels, namely the data and speech sub-channels, there is a request for speech transmission by a unit B which cannot wait for the end of sending of data by the unit A on the speech sub-channel. This unit A sends a request for the sending a large batch of data during the slot P1 at the instant T0. It is assumed that no other unit is sending data or speech at this time. The unit A can therefore send a call on the slot D2 for the occupancy of the data sub-channel and then a call on the slot P2 for the occupancy of the speech sub-channel. Immediately after P2, the unit A starts sending its data on both sub-channels. It is assumed that, during the synchronization slot S that immediately follows P3, a unit B sends a signal requesting speech transmission (namely, the activation of its turn). The data slots sent on the speech sub-channel have a special structure making it possible to watch over the requests for speech alternation (with time intervals reserved for listening to requests for speech alternation). The request by the unit B is sent in this time interval of the slot T4. The synchronization sub-channel is not used in the present case (in theory, it could be used but the reaction time needed to meet the request from the unit B would be lengthier).

The request from the unit B is sent in order that the unit A may release the speech sub-channel. During the slot D4, the unit A sends the remainder of its data normally. Then, during the slot P5, the unit A terminates the use of the speech sub-channel for the data transmission. In D5, the unit A continues sending data normally. Then, in P6, the unit B makes its call for sending speech. From D6 onwards, the unit A continues sending data on the data sub-channel alone and, from P7 onwards, the unit B uses the speech sub-channel to send speech. Naturally, a similar process would be implemented if a unit used both sub-channels to send speech.

What is claimed is:

1. A method to increase the information bit rate in a telecommunications network comprising several stations for the transmission of data and speech, wherein the method consists of the time-multiplexing of the data and speech sub-channels with a general services and synchronization sub-channel to form a frame consisting of an alternation of data, speech and synchronization slots.

2. A method according to claim 1, wherein the synchronization sub-channel is used for tasks pertaining to the links between at least two stations of the network.

3. A method according to claim 2, wherein the tasks comprise at least one of the following tasks: a request for priority transmission formulated by a unit, a warning reported by a unit, a “flash” message, a request for the repetition of a message, commands sent out by the master unit, the reconfiguration of the network.

4. A method according to one of the above claims, wherein each data, speech and synchronization slot comprises a first part reserved for the synchronization with the synchronization signal sent by one of the stations of the network.

5. A method according to one of the above claims, wherein a synchronization signal is sent by the master station of the network on the synchronization sub-channel.

6. A method according to one of the above claims wherein when one of the sub-channels, namely the data or the speech sub-channel, is not busy, it is used for the transmission of the information flowing in the other sub-channel.

7. A method according to one of the above claims, implementing an anti-collision procedure when there are several simultaneous or almost simultaneous requests for the use of a data or speech sub-channel.

8. A method according to claim 7, wherein the anti-collision process consists in assigning a random number to each requesting unit, the unit with the lowest number obtaining the right to send first, and the other units obtaining the right to send in the order corresponding to the rising order of random numbers that have been assigned to them.

9. A method according to claim 7 or 8, wherein the anti-collision process is governed by a rotating rule of priority.

10. A method according to one of the claims 6 to 9, wherein when a first station makes simultaneous use of both the data sub-channel and the speech sub-channel, and when another station requires the use of one of the sub-channels, the first station releases the required sub-channel.
